(19) United States
(12) Patent Application Publication
(10) Pub. No.: US 2026/0002068 A1
(43) Pub. Date: Jan. 1, 2026

(54) ULTRA-HIGH DENSITY WELLBORE FLUIDS PRODUCED THROUGH ALKALIZATION OF AQUEOUS ISOPOLYMETALATE SOLUTIONS

(71) Applicant: Saudi Arabian Oil Company, Dhahran (SA)

(72) Inventor: Elizabeth Q. Contreras, Houston, TX (US)

(73) Assignee: Saudi Arabian Oil Company, Dhahran (SA)

(21) Appl. No.: 18/760,735

(22) Filed: Jul. 1, 2024

(51) Int. Cl. C09K 8/05; C25B 1/04; C25B 15/031; C25B 15/08

(52) U.S. Cl. CPC C09K 8/05; C25B 1/04; C25B 15/031; C25B 15/081

(57) ABSTRACT

A wellbore fluid having a pH greater than or equal to 5 is produced through alkalization of an aqueous electrolyte solution comprising an isopolymetalate. The alkalization of the aqueous electrolyte solution may be performed using an electrolytic cell comprising a chamber configured to hold the aqueous electrolyte solution, a cathode and an anode immersed in the aqueous electrolyte solution, and an electrical power source configured to generate a potential difference between the cathode and the anode. Alkalization-induced redox activities change in surface functional groups drives chemistries in alkaline isopolymetalate-based fluids, increasing amenability to polymers and increasing functionalities. Alkalization by electrolysis of the aqueous electrolyte solution simultaneously produces the wellbore fluid and hydrogen gas.

### TECHNICAL FIELD

The present disclosure generally relates to wellbore fluids.

### BACKGROUND

During the drilling of a wellbore, various wellbore fluids are injected into the well to perform a variety of functions and for primary well control at low and high temperatures, having the criteria for high density (>23 pounds per gallon) while also being solids-free to prevent damage the reservoir. The wellbore fluids may be circulated through a drill pipe and drill bit into the wellbore, and then may subsequently flow upward through wellbore to the surface. During this circulation, a wellbore fluid may transport drill cuttings from the bottom of the hole to the surface, suspend cuttings and weighting material when circulation is interrupted, control subsurface pressures, maintain the integrity of the wellbore until the well section is cased and cemented, isolate the wellbore fluids from the formation by providing sufficient hydrostatic pressure to prevent the ingress of formation fluids into the wellbore, cool and lubricate the drill string and bit, and/or increase the penetration rate.

Wellbore fluids having high alkalinity may be advantageous for several reasons. For example, alkaline wellbore fluids may reduce corrosion rates, improve the stability of fluid additives, and reduce the degree of formation damage during drilling. Traditionally, the pH of wellbore fluids is controlled using chemical additives such as buffering agents, sodium hydroxide, and hydrochloric acid. However, the use of such chemical additives in combination with polymer additives for controlling various fluid properties may cause the wellbore fluids to sag within weeks, months, or years.

As an alternative to traditional pH additives, ion membrane electrolysis of, for example, seawater may be used to produce alkaline fluids. However, alkalized seawater does not have the high density needed for wellbore application and, due to the presence of sodium chloride, electrolyzing seawater or saline water results in the generation of chlorine gas at the anode side of the electrolytic cell, which may re-dissolve back in the water and thus decrease the pH value of the water. This consequently affects the rate or performance of generating alkaline fluids. In addition, chlorine gas is an environmental concern.

### SUMMARY

Accordingly, a need exists for high-density alkaline wellbore fluids wherein the increased alkalinity is achieved without the use of traditional pH additives and without conventional production methods involving the electrolysis of seawater or saline water. The present disclosure is directed to wellbore fluids meeting this need that are produced through alkalization of aqueous electrolyte solutions comprising an isopolymetalate, wherein the resulting wellbore fluid has a pH greater than or equal to 5. The alkalization-induced fluids described herein are clear, ultra-high density fluids (e.g., greater than 23 pounds/gallon) that are zinc- and cesium-free and resistant to high temperatures. It has been found that the alkalization of aqueous isopolymetalate solutions may be performed via electrolysis or through the use of reducing agents.

By avoiding the use of traditional pH control additives and polymer additives, the wellbore fluids described herein can avoid or mitigate coagulation behavior at higher temperatures. The addition of polymers in a high-density fluid (brine-saturated) increases the rate of aggregation causing the solution to precipitate solids and become cloudy with limited functionality at low temperatures. Additionally, reducing the amount of additives and admixtures for wellbore fluids allows for: higher concentrations of brine in solution for high-density applications; low reactivity for higher stability; robustness for increased compatibility with downhole fluids; and thermal resistance for high temperature applications when using the wellbore fluids as completion fluids, for example. The wellbore fluids described herein may be used in a wide range of applications including, but not limited to, as drill-in fluids in oil and gas wells, and in geothermal wells. Moreover, the wellbore fluids described herein have higher densities than commercially available wellbore fluids (e.g., having densities up to 19 pounds per gallon) and are substantially free of zinc and cesium.

Moreover, by avoiding conventional methods involving the electrolysis of seawater or saline water, the polymetalate wellbore fluids described herein may be produced with improved pH control and without the generation of chlorine gas. As such, the wellbore fluids of the present disclosure may: be produced in an environmentally friendly manner; assist in the production of alternate energy hydrogen gas from alkalization-induced deprotonation by electrolysis; allow for reduced corrosion rates; improve the redox activity of the chemical surface for modification by an additive for enhanced thermal stability; achieve robust solubility of fluids for high temperature applications; and, as solids-free fluids, decrease formation damage during drilling and completions operations.

Isopolymetalate brine is highly soluble in water but an increase in temperature causes solubility retrograde, leading to sagging and supramolecular aggregates. It has been found that the electron-accepting capacity of isopolymetalate brines may accelerate electrolytic reduction by shuttling electrons from electrode to oxide surfaces to form functionalized oxygenated moieties. This allows for the electrochemically active isopolymetalate solutions to be chemically modified for wellbore conditions and fluids applications.

Alkalization was found to reduce terminal or doubly bridging oxo ligands of isopolymetalate fluids, thereby changing the chemical structure, color, and redox properties of isopolymetalate fluids. In embodiments, the pH value of isopolymetalate fluids varies from 1 to 7; and up to 12, for example, when modified with amine functional groups (condensation reactions). Under acidic conditions, isopolymetalate fluids are stabilized by the physiochemical properties that allows for low coagulation behavior and highly dispersive isopolymetalate anions, leading to ultra-high density supersaturated fluids. Alkalization using electrochemistry affects the redox activity of isopolymetalate fluids via changes to the physicochemical properties. For example, as alkalization causes pH to change in the range of 1 to 7, chemical modifications of the isopolymetalates occur with more functional group exposure in alkaline conditions. As mentioned above, functional group exposure was achieved by either electrophoresis or by a reducing agent (chemical redox reactions), producing a mix of oxygen and hydrogen gas and causing a change in the physicochemical properties of the ultra-high density fluid. Moreover, when reacted with a modifying agent, temperature resistance for the wellbore fluid of up to 300° F. was achieved.

Additionally, the methods described herein for producing wellbore fluids may be dual-purposed for the production of hydrogen. Hydrogen is gaining attention due to its potential replacement of fossil fuels as an energy carrier. Electrolysis routes for the production of hydrogen are attractive because the electricity used to facilitate the electrolysis may be obtained from renewable energy sources.

Electrolysis processes utilize a conductive aqueous solution formed as a mixture of electrolytes (solute) in water (solvent), the solute being partly or wholly in the form of ions in solution. Ions are charged particles having significant electrostatic interactions between other ions in solution and with the solvent. As the concentration of solute (ions) increases, electrostatic interactions, such as cation/anion, cation/cation, and anion/anion, increase as well. Parameters such as ion size, shape, distribution of charge, polarity, ionic strength, redox activity, and degree of solute dissociation into ions are key topics in electrolyte optimization. The macroscopic electrolyte properties of the solution is the sum of all possible electrostatic interactions.

Saline is a mixture of sodium chloride (NaCl) and water, with the dissociated sodium and chloride ions acting as the electrolytes in solution. Seawater contains a number of dissociated solutes including CaCl₂, MgCl₂, KCl, NaCl, and Na₂SO₄. However, as mentioned above in the context of alkaline fluid production via electrolysis, saline and seawater are not ideal candidates for the electrolytic production of hydrogen due to the generation of chlorine gas. Therefore, a need exists for improved electrolytic processes for the production hydrogen. The present disclosure meets this need by providing a method for generating hydrogen gas wherein an aqueous electrolyte solution comprising an isopolymetalate is subjected to electrolysis.

A first aspect of the present disclosure includes a wellbore fluid produced through alkalization of an aqueous electrolyte solution comprising an isopolymetalate, wherein the wellbore fluid as a pH greater than or equal to 5.

A second aspect includes the first aspect, wherein the isopolymetalate comprises an isopolytungstate.

A third aspect includes any one of the first or second aspects, wherein the aqueous electrolyte solution comprises sodium metatungstate, ammonium metatungstate, or both, and wherein the isopolymetalate comprises metatungstate from the sodium metatungstate, ammonium metatungstate, or both.

A fourth aspect includes any one of the first or second aspects, wherein the aqueous electrolyte solution comprises an isopolymetalate salt comprising an anion and a cation, wherein the isopolymetalate is the anion of the isopolymetalate salt.

A fifth aspect includes the fourth aspect, wherein the isopolymetalate salt is present in the aqueous electrolyte solution in an amount between 10 wt % and 90 wt %, based on the total weight of the aqueous electrolyte solution.

A sixth aspect includes the fourth aspect, wherein the isopolymetalate salt is present in the aqueous electrolyte solution in an amount between 25 wt % and 80 wt %, based on the total weight of the aqueous electrolyte solution.

A seventh aspect includes the fourth aspect, wherein the isopolymetalate salt is present in the aqueous electrolyte solution in an amount between 50 wt % and 75 wt %, based on the total weight of the aqueous electrolyte solution.

An eighth aspect includes any one of the first through seventh aspects, wherein before being alkalized, the aqueous electrolyte solution has a pH less than or equal to 4.0.

A ninth aspect includes any one of the first through eighth aspects, wherein the wellbore fluid is substantially free of chlorine, zinc, and cesium.

A tenth aspect includes any one of the first through ninth aspects, wherein the alkalization is performed using an electrolytic cell comprising: a chamber configured to hold the aqueous electrolyte solution; a cathode immersed in the aqueous electrolyte solution; an anode immersed in the aqueous electrolyte solution and fluidly connected to the cathode; and an electrical power source configured to generate a potential difference between the cathode and the anode.

According to an eleventh aspect of the present disclosure, a method for producing a wellbore fluid comprises alkalizing an aqueous electrolyte solution comprising an isopolymetalate.

A twelfth aspect includes the eleventh aspect, wherein the alkalizing comprises: providing an aqueous electrolyte solution in a chamber, the aqueous electrolyte solution comprising an isopolymetalate; immersing a cathode in the aqueous electrolyte solution; immersing an anode in the aqueous electrolyte solution such that the anode is fluidly connected to the cathode; and generating a potential difference between the cathode and the anode to alkalize the aqueous electrolyte solution and produce the wellbore fluid, wherein the wellbore fluid has a pH greater than or equal to 5.

A thirteenth aspect includes any one of the eleventh or twelfth aspects, wherein the isopolymetalate comprises an isopolytungstate.

A fourteenth aspect includes any one of the eleventh through thirteenth aspects, wherein the aqueous electrolyte solution comprises sodium metatungstate, ammonium metatungstate, or both, and wherein the isopolymetalate comprises metatungstate from the sodium metatungstate, ammonium metatungstate, or both.

A fifteenth aspect includes any one of the eleventh through fourteenth aspects, wherein the alkalizing comprises contacting the aqueous electrolyte solution comprising an isopolymetalate with a reducing agent.

A sixteenth aspect includes the fifteenth aspect, wherein the reducing agent comprises sodium borohydride (NaBH₄).

A seventeenth aspect includes any one of the eleventh through sixteenth aspects, further comprising contacting the alkalized aqueous electrolyte solution with a modifying agent thereby forming a modified alkalized isopolymetalate solution.

An eighteenth aspect includes the seventeenth aspect, wherein the modifying agent is selected from the group consisting of (3-glycidoxypropyl)trimethoxysilane, sodium glucoheptonate, benzaldehyde, benzophenone, silicates, adamantylamine, and combinations thereof.

According to a nineteenth aspect of the present disclosure, a method for generating hydrogen gas comprises providing an aqueous electrolyte solution in a chamber, the aqueous electrolyte solution comprising an isopolymetalate; immersing a cathode in the aqueous electrolyte solution; immersing an anode in the aqueous electrolyte solution such that the anode is fluidly connected to the cathode; and generating a potential difference between the cathode and the anode to alkalize the aqueous electrolyte solution and produce hydrogen gas.

A twentieth aspect includes the nineteenth aspect, wherein the aqueous electrolyte solution comprises an isopolymetalate salt comprising an anion and a cation, wherein the isopolymetalate is the anion of the isopolymetalate salt.

A twenty-first aspect includes the twentieth aspect, wherein the isopolymetalate salt is present in the aqueous electrolyte solution in an amount between 10 wt % and 90 wt %, based on the total weight of the aqueous electrolyte solution.

A twenty-second aspect includes any one of the nineteenth through twenty-first aspects, wherein the aqueous electrolyte solution comprises sodium metatungstate, ammonium metatungstate, or both, and wherein the isopolymetalate comprises metatungstate from the sodium metatungstate, ammonium metatungstate, or both.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an electrolytic cell that may be used for the production of a wellbore fluid through the alkalization of an aqueous electrolyte solution, in accordance with one or more embodiments described herein;

FIG. 2 is a plot showing the first derivative of thermogravimetric analysis results for sodium metatungstate and ammonium metatungstate;

FIG. 3A is a plot showing hydrogen production during electrolysis of an aqueous electrolyte solution comprising sodium metatungstate at 80 wt % based on the total weight of the aqueous electrolyte solution, according to one or more embodiments described herein;

FIG. 3B is a plot showing hydrogen production during a second cycle of electrolysis of the aqueous electrolyte solution comprising sodium metatungstate at 80 wt % based on the total weight of the aqueous electrolyte solution, according to one or more embodiments described herein;

FIG. 3C is a plot showing hydrogen production during a third cycle of electrolysis of the aqueous electrolyte solution comprising sodium metatungstate at 80 wt % based on the total weight of the aqueous electrolyte solution, according to one or more embodiments described herein;

FIG. 4 is a plot showing hydrogen production during electrolysis of an aqueous electrolyte solution comprising sodium metatungstate at 71.4 wt % based on the total weight of the aqueous electrolyte solution, according to one or more embodiments described herein;

FIG. 5 is a plot showing hydrogen production during electrolysis of an aqueous electrolyte solution comprising sodium metatungstate at 50 wt % based on the total weight of the aqueous electrolyte solution, according to one or more embodiments described herein;

FIG. 6 is a plot showing hydrogen production during electrolysis of saline;

FIG. 7A is a plot showing hydrogen production during electrolysis of synthetic Arabian seawater;

FIG. 7B is a photograph showing precipitation at the cathode of an electrolytic cell after ten minutes of electrolysis of synthetic Arabian seawater;

FIG. 7C is a photograph showing precipitation at the cathode of an electrolytic cell after thirty minutes of electrolysis of synthetic Arabian seawater;

FIG. 8A is a plot showing hydrogen production during electrolysis of an aqueous electrolyte solution comprising sodium metatungstate at 71.4 wt % based on the total weight of the aqueous electrolyte solution, wherein the cathode and the anode were platinum electrodes, according to one or more embodiments described herein; and

FIG. 8B is a plot showing hydrogen production during electrolysis of an aqueous electrolyte solution comprising sodium metatungstate at 71.4 wt % based on the total weight of the aqueous electrolyte solution, wherein the cathode and the anode were graphite electrodes, according to one or more embodiments described herein.

### DETAILED DESCRIPTION

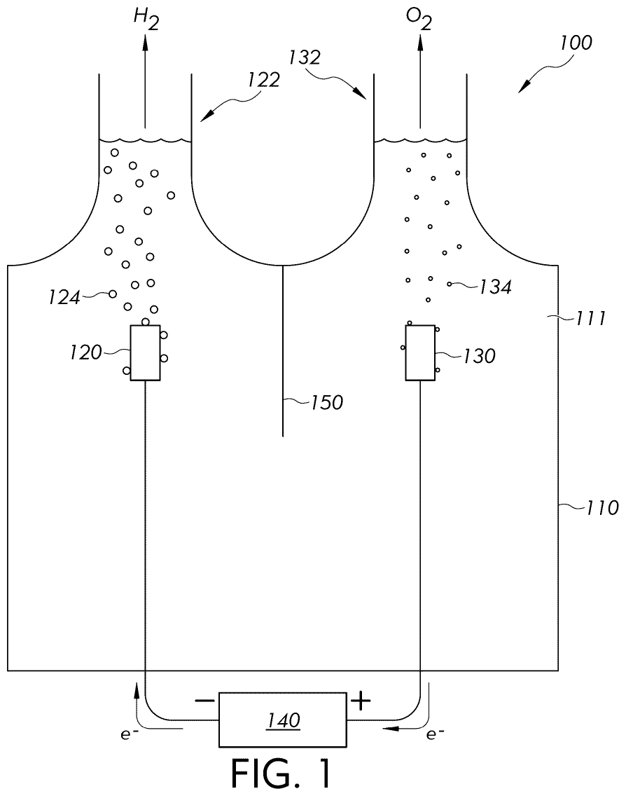

The present disclosure generally relates to wellbore fluids produced through alkalization of an aqueous electrolyte solution comprising an isopolymetalate, wherein the resulting wellbore fluid has a pH greater than or equal to 5. The alkalization of the aqueous electrolyte solution may be performed using an undivided electrolytic cell 100 as schematically depicted in FIG. 1. The electrolytic cell 100 comprises a chamber 110 configured to hold an aqueous electrolyte solution 111. The electrolytic cell 100 further comprises a cathode 120 and an anode 130, both of which are immersed in the aqueous electrolyte solution 111. An electrical power source 140 generates a potential difference between the cathode 120 and the anode 130 to cause electrolysis of the aqueous electrolyte solution 111. The isopolymetalate and derivatives thereof in the aqueous electrolyte solution 111 facilitate the electrolysis process, which results in the production of hydrogen gas 124 at the cathode 120 and the production of oxygen gas 134 at the anode 130. The electrolytic cell 100 may comprise a hydrogen gas collector 122 for collecting hydrogen gas 124 produced at the cathode 120, and an oxygen gas collector 132 for collecting oxygen gas 134 produced at the anode 130. The electrolytic cell 100 may further comprise a partition 150 that partially divides the chamber 110 to prevent substantial mixing of hydrogen gas 124 produced at the cathode 120 and oxygen gas 134 produced at the anode 130. The alkalization of the aqueous electrolyte solution 111 using the electrolytic cell 100 may be performed to simultaneously produce an alkaline fluid for wellbore applications and to generate valuable hydrogen gas.

In the context of the present disclosure, reference to a fluid as alkaline means that the fluid has a pH greater than or equal to 5.

As used herein, the term “polymetalate” or “polyoxometalate” refers to a polyatomic ion, usually an anion, that consists of three or more transition metal oxyanions linked together by shared oxygen atoms to form 3-dimensional frameworks, also referred to as clusters. The transition metal atoms of the transition metal oxyanions may be selected from IUPAC group 4 (Ti, Zr, Hf), IUPAC group 5 (V, Nb, Ta), or IUPAC group 6 (Cr, Mo, W). A polymetalate salt is an ionic compound of a polymetalate anion and one or more cations (e.g., alkali metal cations, alkaline earth metal cations, ammonium cations, lead, manganese, iron, etc.) that balance the negative charge of the polymetalate anion.

As used herein, the term “isopolymetalate” refers to a polymetalate composed of one type of metal, oxygen, and, if protonated, hydrogen. Isopolymetalates can be contrasted with heteropolymetalates in that the latter are composed of one type of metal, oxygen, hydrogen (if protonated), and a main group oxyanion (e.g., phosphate, silicate, etc.). Isopolymetalates of the present disclosure may be represented by the general formula [HₓM_{y}O_{z}]^{q-}(Formula I), where H is hydrogen, M is an element selected from the transition metals in IUPAC groups 4-6, O is oxygen, x is an integer from 0 to 12, y is an integer equal to 3, 4, 5, 6, 7, 8, 9, 10, 11, 12, or 18, z is an integer from 12 to 72, and q is an integer from 1 to 20. An isopolymetalate salt is an ionic compound of an isopolymetalate anion and one or more cations (e.g., alkali metal cations, alkaline earth metal cations, ammonium cations, lead, manganese, iron, etc.) that balance the negative charge of the isopolymetalate anion.

In embodiments, the isopolymetalate of the aqueous electrolyte solution 111 is an isopolytungstate of Formula I, where M is tungsten. In embodiments, the isopolytungstate is selected from the group consisting of metatungstate having the formula [W₁₂O₄₀]⁸⁻, paratungstate A having the formula [W₇O₂₄]⁶⁻, paratungstate B having the formula [W₁₂O₄₂]¹²⁻, tungstate Y having the formula [W₁₀O₃₂]⁴⁻, protonated derivatives thereof, and combinations thereof.

In embodiments, the aqueous electrolyte solution 111 comprises an isopolymetalate salt comprising an anion and a cation, wherein the isopolymetalate is the anion of the isopolymetalate salt. The isopolymetalate salt may be present in the aqueous electrolyte solution in an amount between 10 wt % and 90 wt %, between 25 wt % and 80 wt %, between 25 wt % and 75 wt %, between 50 wt % and 80 wt %, between 50 wt % and 75 wt %, between 55 wt % and 80 wt %, between 55 wt % and 75 wt %, between 60 wt % and 80 wt %, between 60 wt % and 75 wt %, between 60 wt % and 72 wt %, between 64 wt % and 72 wt %, or between 68 wt % and 72 wt %, based on the total weight of the aqueous electrolyte solution 111. In embodiments, prior to being alkalized, the aqueous electrolyte solution 111 may have a pH less than or equal to 4.0, less than or equal to 3.5, or less than or equal to 3.0. In embodiments, prior to being alkalized, the aqueous electrolyte solution 111 may have a pH greater than or equal to 1.0 and less than or equal to 4.0, greater than or equal to 1.5 and less than or equal to 4.0, greater than or equal to 2.0 and less than or equal to 4.0, greater than or equal to 2.5 and less than or equal to 4.0, greater than or equal to 3.0 and less than or equal to 4.0, greater than or equal to 3.25 and less than or equal to 4.0, or greater than or equal to 3.25 and less than or equal to 3.75.

In embodiments, the wellbore fluid produced through alkalization of the aqueous electrolyte solution 111 has a pH greater than or equal to 5, pH greater than or equal to 6, greater than or equal to 6.5, greater than or equal to 7.0, greater than or equal to 7.5, greater than or equal to 8.0, greater than or equal to 8.5, or greater than or equal to 9.0. In embodiments, the wellbore fluid produced through alkalization of the aqueous electrolyte solution 111 has a pH greater than or equal to 5 and less than or equal to 10, greater than or equal to 6 and less than or equal to 10, greater than or equal to 6.5 and less than or equal to 10, greater than or equal to 7.0 and less than or equal to 10, greater than or equal to 7.5 and less than or equal to 10, greater than or equal to 8.0 and less than or equal to 10, greater than or equal to 8.5 and less than or equal to 10, or greater than or equal to 9.0 and less than or equal to 10.

In embodiments wherein the isopolymetalate is an isopolytungstate, the isopolytungstate may be the anion of an isopolymetalate salt and the isopolymetalate salt may comprise at least one of Na or NH4+ as the charge balancing cation(s). In embodiments, the aqueous electrolyte solution 111 comprises sodium metatungstate, and the isopolymetalate comprises metatungstate from the sodium metatungstate. In embodiments, the aqueous electrolyte solution 111 comprises ammonium metatungstate, and the isopolymetalate comprises metatungstate from the ammonium metatungstate.

Suitable materials for the cathode 120 and the anode 130 include, but are not limited to, platinum, platinum oxide, palladium, iridium, iridium oxide, indium-tin oxide, graphite, steel, and tungsten trioxide. The cathode 120 and the anode 130 may comprise the same material or different materials relative to other. In embodiments, the cathode 120 and the anode 130 comprise graphite. In embodiments, the cathode 120 and the anode 130 comprise platinum. The potential difference generated between the cathode 120 and the anode 130 in the methods described herein may be greater than or equal to 12 V (volts) and less than or equal to 48 V. In embodiments, the potential difference between the cathode 120 and the anode 130 is about 24 V. The amount of time that the aqueous electrolyte solution 111 is subjected to electrolysis will depend on the volume of the aqueous electrolyte solution 111 being alkalized. In embodiments, the alkalization of the aqueous electrolyte solution 111 is performed in multiple cycles wherein the alkalized product of each cycle (except for the final cycle) is recycled for repeated electrolysis operations.

Without wishing to be bound by theory, it is believed that the isopolymetalate and its protonated derivatives in the aqueous electrolyte solution 111 facilitate the electrolysis process by lowering the kinetic barrier to splitting water into hydrogen and oxygen. During alkalization by electrolysis of supersaturated isopolymetalate solutions described herein having significantly less free water, an increase in deprotonation of functional groups and the weakening of hydrogen bonds of the isopolymetalate may occur in addition to water splitting. During the electrolysis process, electrons are supplied to the aqueous electrolyte solution 111 from the cathode 120 and withdrawn from the aqueous electrolyte solution 111 through the anode 130. Without wishing to be bound by theory, some of the specific mechanisms in which the isopolymetalate is believed to facilitate the electrolysis process are now described for an exemplary embodiment wherein the isopolymetalate comprises metatungstate, wherein the number of redox-active functional group and their redox potentials allow for changes in chemical structure and redox properties.

When the aqueous electrolyte solution 111 is acidic (e.g., having a pH less than 3) where deprotonation during alkalization occurs, electrons supplied to the aqueous electrolyte solution 111 at the cathode 120 may participate in the reaction shown in Equation 1 below, where metatungstate is reduced to paratungstate A and hydrogen gas 124 is produced.

$${7 [ {H}_{2} {W}_{12} {O}_{40} ]}^{6 -} + 22 {e}^{-} + 8 {OH}^{-} \to {12 [ {W}_{7} {O}_{24} ]}^{{6}^{-}} + 11 {H}_{2} ( g ) \qquad Equation 1$$

Under the same acidic conditions, oxygen gas 134 may be produced at the anode 130 in accordance with Equation 2 below.

$${7 [ {H}_{2} {W}_{12} {O}_{40} ]}^{6 -} + 30 {OH}^{-} \to {12 [ {W}_{7} {O}_{24} ]}^{{6}^{-}} + 44 {e}^{-} + 44 {H}^{+} + 11 {O}_{2} ( g ) \qquad Equation 2$$

When the aqueous electrolyte solution 111 is slightly acidic (e.g., having a pH between 3 and 6), electrons supplied to the aqueous electrolyte solution 111 at the cathode 120 may participate in the reaction shown in Equation 3 below, where metatungstate is reduced to protonated paratungstate B and hydrogen gas 124 is produced.

$${7 [ {H}_{2} {W}_{12} {O}_{40} ]}^{6 -} + 16 {e}^{-} + 14 {OH}^{-} + 2 {H}^{+} \to {7 [ {H}_{2} {W}_{12} {O}_{24} ]}^{{10}^{-}} + 8 {H}_{2} ( g ) \qquad Equation 3$$

Under the same slightly acidic conditions, oxygen gas 134 may be produced at the anode 130 in accordance with Equation 4 below.

$${7 [ {H}_{2} {W}_{12} {O}_{40} ]}^{6 -} + 30 {OH}^{-} \to {7 [ {H}_{2} {W}_{12} {O}_{42} ]}^{{10}^{-}} + 32 {e}^{-} + 30 {H}^{+} + 8 {O}_{2} ( g ) \qquad Equation 4$$

When the aqueous electrolyte solution 111 is neutral to basic (e.g., having a pH between 6 and 10), electrons supplied to the aqueous electrolyte solution 111 at the cathode 120 may participate in the reaction shown in Equation 5 below, where metatungstate is reduced to tungstate ions and hydrogen gas 124 is produced.

$${7 [ {H}_{2} {W}_{12} {O}_{40} ]}^{6 -} + 70 {e}^{-} + 56 {OH}^{-} \to {84 [ {WO}_{4} ]}^{2 -} + 35 {H}_{2} ( g ) \qquad Equation 5$$

Under the same neutral to basic conditions, oxygen gas 134 may be produced at the anode 130 in accordance with Equation 6 below.

$${7 [ {H}_{2} {W}_{12} {O}_{40} ]}^{6 -} + 128 {OH}^{-} \to {84 [ {WO}_{4} ]}^{2 -} + 144 {e}^{-} + 142 {H}^{+} + 36 {O}_{2} ( g ) \qquad Equation 6$$

The electrolysis reactions shown above in Equations 1-6 are presented merely as potential reactions at the cathode 120 and anode 130. Those skilled in the art would understand that additional and/or alternative electrolysis reactions aided by isopolymetalate derivatives may also occur. For example, under neutral to basic conditions, paratungstate A and/or paratungstate B may be reduced to tungstate ions at the cathode 120 with a corresponding production of hydrogen gas. The production of hydrogen gas from the aqueous electrolyte solution 111 results in a decrease in the proton activity (i.e., deprotonation and an increase in pH) of the aqueous electrolyte solution 111. In this manner, the aqueous electrolyte solution 111 may be alkalized to form a wellbore fluid.

Previous efforts to produce hydrogen gas using electrolysis processes have implemented heteropolymetalates as polymetalate mediators in two-stage electrolysis processes. In contrast, the methods described herein subject aqueous polymetalate solutions to electrolysis using an undivided electrolytic cell chamber design (i.e., without an ion exchange membrane separating a cathode chamber and an anode chamber). Without wishing to be bound by theory, it is believed that the undivided chamber design implemented in the methods described herein allows the pH to change as gases are produced and released from the system (e.g., through the hydrogen gas collector 122 and the oxygen gas collector 132). Moreover, while the present disclosure focuses on the alkalization of aqueous electrolyte solutions including an isopolymetalate, it should be understood that aqueous electrolyte solutions including a heteropolymetalate, or a combination an isopolymetalate and a heteropolymetalate, may be used with the undivided chamber design described here for the electrolytic production of hydrogen gas and/or wellbore fluids.

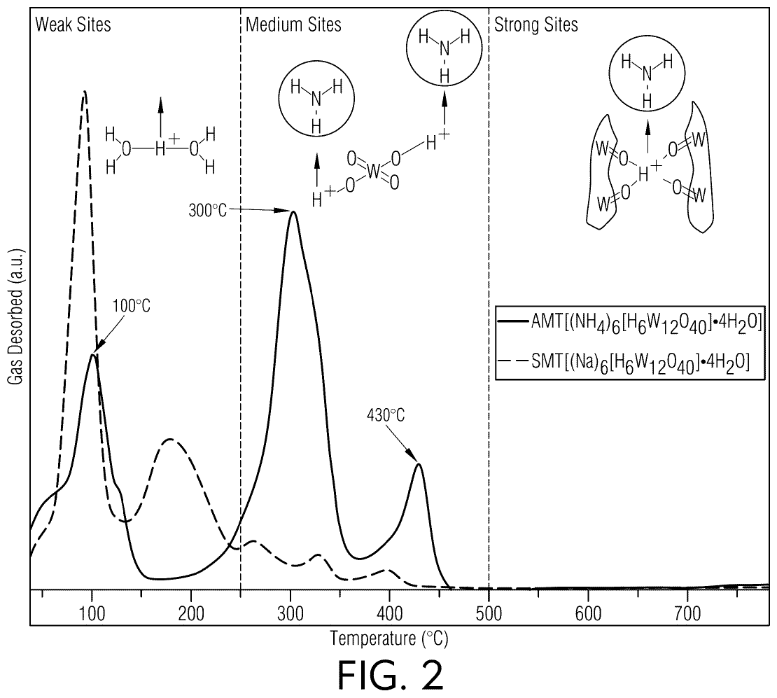

To further understand the activity of the isopolymetalate in the aqueous electrolyte solution 111, a thermogravimetric analysis (TGA) study was performed using exemplary isopolymetalates, sodium metatungstate and ammonium metatungstate. The results of the TGA study are shown in FIG. 2, which plots the first derivative of the TGA curve (rate of weight loss) against temperature to illustrate the strength of binding sites present on these exemplary isopolymetalates. At temperatures up to 200° C., the desorption of free and bound water from the sodium metatungstate sample can be seen with a peak slightly below 100° C. In the 250° C. to 500° C. range, three peaks in the sodium metatungstate TGA curve can be seen, indicating the desorption of small molecules. The ammonium metatungstate TGA indicates dehydration at 100° C., and the broader peak between 250° C. to 500° C. is believed to correspond with the desorption of NH₃ (peaks at 300° C. and 430° C.). The presence of multiple peaks in the TGA curves for both sodium metatungstate and ammonium metatungstate indicates that these isopolymetalates have a range of hydrogen binding sites of differing strengths. Without wishing to be bound by theory, it is believed that hydrogen ions may bind to these sites when the isopolymetalate is in the aqueous electrolyte solution 111, and that electrons supplied to the aqueous electrolyte solution 111 at the cathode 120 may cause these hydrogen ions to desorb from binding sites on the isopolymetalate and combine to form hydrogen gas.

Referring again to FIG. 1, methods of the present disclosure for producing a wellbore fluid may comprise providing an aqueous electrolyte solution 111 in a chamber 110, the aqueous electrolyte solution 111 comprising an isopolymetalate, immersing a cathode 120 and an anode 130 in the aqueous electrolyte solution 111 such that the anode 130 is fluidly connected to the cathode 120, and generating a potential difference between the cathode 120 and the anode 130 to alkalize the aqueous electrolyte solution 111 and produce the wellbore fluid having a pH greater than or equal to 5. The methods for producing a wellbore fluid may be performed in various contexts relative to a wellbore drilling operation, as well as geothermal operations. For example, the methods described herein may be performed above surface, in situ, or in between. Moreover, the methods described herein may be implemented upstream from a wellbore drilling operation to produce the wellbore fluid, and then again downstream from a wellbore drilling operation to produce hydrogen gas from recycled brine solution following use in the wellbore. Therefore, the alkalization of the aqueous electrolyte solution 111 using the methods described herein may simultaneously or separately be implemented to produce an alkaline fluid for wellbore applications and to generate valuable hydrogen gas.

In combination with or as an alternative to the above-discussed electrolytic alkalization methods, alkalization of aqueous electrolyte solutions for the production of wellbore fluids may also be performed by contacting the aqueous electrolyte solution with a reducing agent, such as, for example, NaBH₄. Without wishing to be bound by theory, alkalization by either electrolysis or a reducing agents leads to solutions with oxygen content and higher density of functionalization. In addition to increasing pH, the experiments described herein show that alkalizing the aqueous isopolymetalate solutions facilitates interfacial modifications of the isopolymetalate. This is key for the further modification of fluid properties, e.g., toward fluids with high temperature applications, favorable pH to mitigate corrosion, stability for solids-free fluids, lubricity, viscosity for downhole applications, etc. Key reactions for surface functionalization of alkalized isopolymetalates with increased oxygen moieties include reactions with modifying agents having multifunctional moieties, such as (3-glycidyloxypropyl)trimethoxysilane, sodium glucoheptonate, benzaldehyde, benzophenone, silicates, and adamantylamine. In embodiments, methods described herein for producing wellbore fluids may further comprise contacting the alkalized aqueous electrolyte solution with a modifying agent selected from the group consisting of bis(2-ethylhexyl) phthalate, (3-glycidoxypropyl)trimethoxysilane, sodium glucoheptonate, benzaldehyde, benzophenone, silicates, adamantylamine, and combinations thereof.

The methods of the present disclosure for producing hydrogen gas may comprise providing an aqueous electrolyte solution 111 in a chamber 110, the aqueous electrolyte solution 111 comprising an isopolymetalate, immersing a cathode 120 and an anode 130 in the aqueous electrolyte solution 111 such that the anode 130 is fluidly connected to the cathode 120, and generating a potential difference between the cathode 120 and the anode 130 to alkalize the aqueous electrolyte solution 111 and produce hydrogen gas.

EXAMPLES

The embodiments described herein will be further clarified by the following examples. The following examples demonstrate the application of the methods described herein for the production of alkaline wellbore fluids and the generation of hydrogen gas. In particular, for some of the examples that follow, various aqueous electrolyte solutions were prepared and subjected to electrolysis in accordance with the methods described herein. Table 1 below provides, for each of the samples tested, the electrolyte content, the density, the initial pH, the pH after sixty minutes of electrolysis (24.1 V potential difference, room temperature, graphite electrodes, 150 mL initial solution volume), and the measured rate of hydrogen gas generation. A Hoffman Electrolysis Apparatus was used to perform the electrolysis.

| | | Electrolyte | | | | |
|---|---|---|---|---|---|---|
| | | content (wt % | | | | |
| | | based on total | | | | |
| | | weight of | Density | Initial | pH after 60 | H₂ Generation |
| Sample | Electrolyte | solution) | (g/mL) | pH | minutes | Rate (mL/min) |
| 1 | Sodium | 80 | 2.83 | 2.91 | 5.77-6.26 | 0.50 |
| | metatungstate* | | | | | |
| 2 | Sodium | 71.4 | 2.18 | 3.45 | 6.82-6.86 | 0.88 |
| | metatungstate* | | | | | |
| 3 | Sodium | 50 | 1.70 | 3.66 | 7.23-7.78 | 0.78 |
| | metatungstate* | | | | | |
| 4 | NaCl | 9.1 | 1.00 | 6.31 | 8.78 | 0.15 |
| 5 | Seawater | 4.8 | 1.06 | 6.31 | 9.88 | 0.87 |
| | electrolytes | | | | | |

*Sodium metatungstate monohydrate (CAS 12141-67-2; reagent grade)
^{†} Synthetic Arabian seawater composition including CaCl₂ (1.71 g/L), MgCl₂ (8.26 g/L), KCl (1.13 g/L), NaCl (41.72 g/L), and Na₂SO₄ (6.12 g/L)

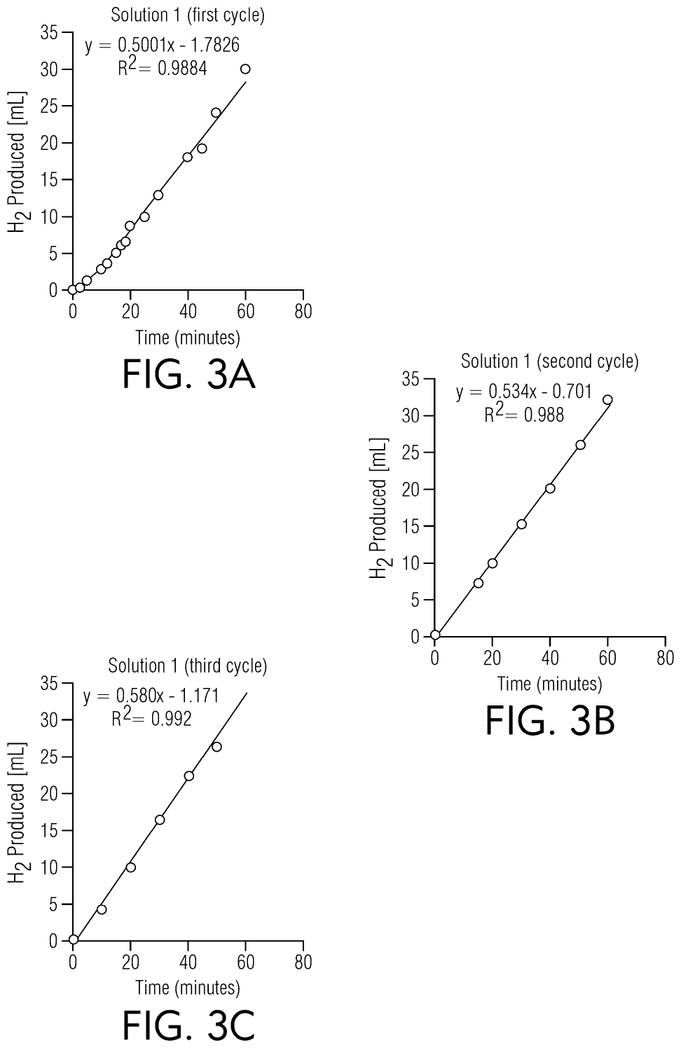

FIGS. 3A-3C are plots showing hydrogen production during three 60-minute electrolysis cycles of Sample 1 comprising sodium metatungstate at 80 wt % based on the total weight of the aqueous electrolyte solution. The consistent (slightly increasing) hydrogen production rate for the three electrolysis cycles shown in FIGS. 3A-3C demonstrates that the ability of the isopolymetalate to facilitate electrolysis for multiple cycles and over a range of pH levels for the aqueous electrolyte solution.

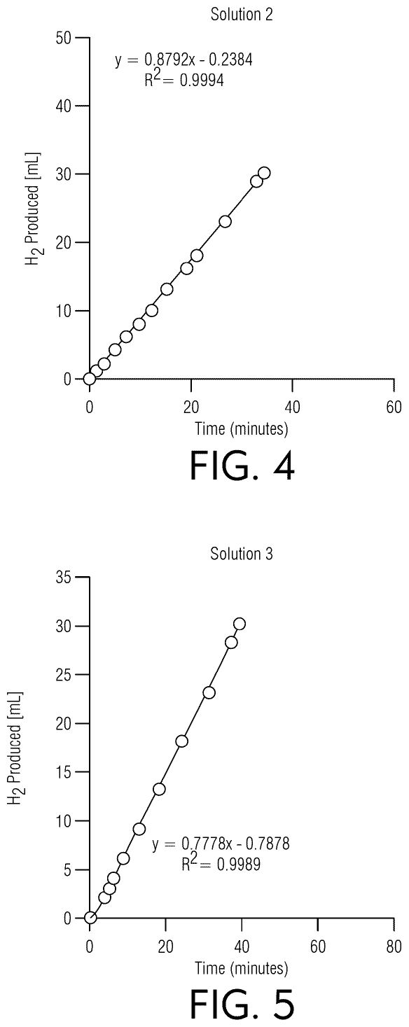

FIG. 4 is a plot showing hydrogen production during electrolysis of Sample 2 comprising sodium metatungstate at 71.4 wt % based on the total weight of the aqueous electrolyte solution. FIG. 5 is a plot showing hydrogen production during electrolysis of Sample 3 comprising sodium metatungstate at 50 wt % based on the total weight of the aqueous electrolyte solution. With reference to Table 1 and FIGS. 3A, 4, and 5, it can be seen that the aqueous electrolyte solution containing 71.4 wt % sodium metatungstate demonstrated a higher hydrogen production rate than both the 50 wt % sodium metatungstate (Sample 3) and 80 wt % sodium metatungstate (Sample 1) solutions. The increased hydrogen production rate for Sample 2 shows that the concentration of the isopolymetalate and the associated electrostatic interactions in the electrolyte solution affect the degree to which the isopolymetalate and its protonated derivatives are able to facilitate the electrolysis process, e.g., by lowering the kinetic barrier to splitting water into hydrogen and oxygen.

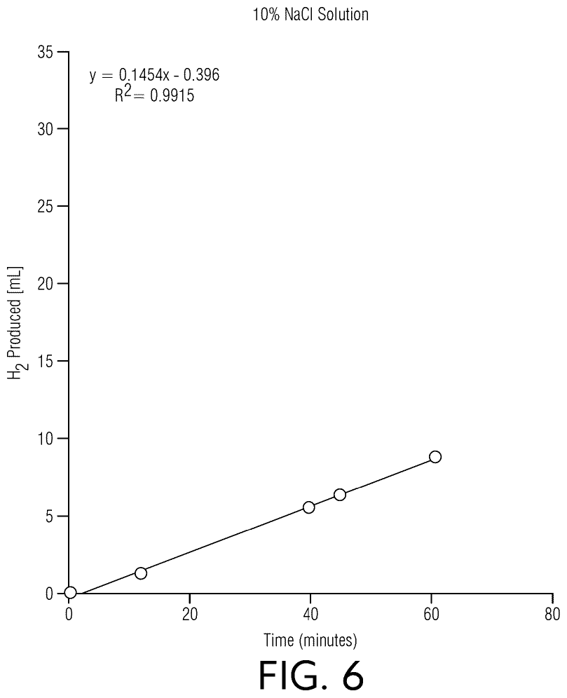

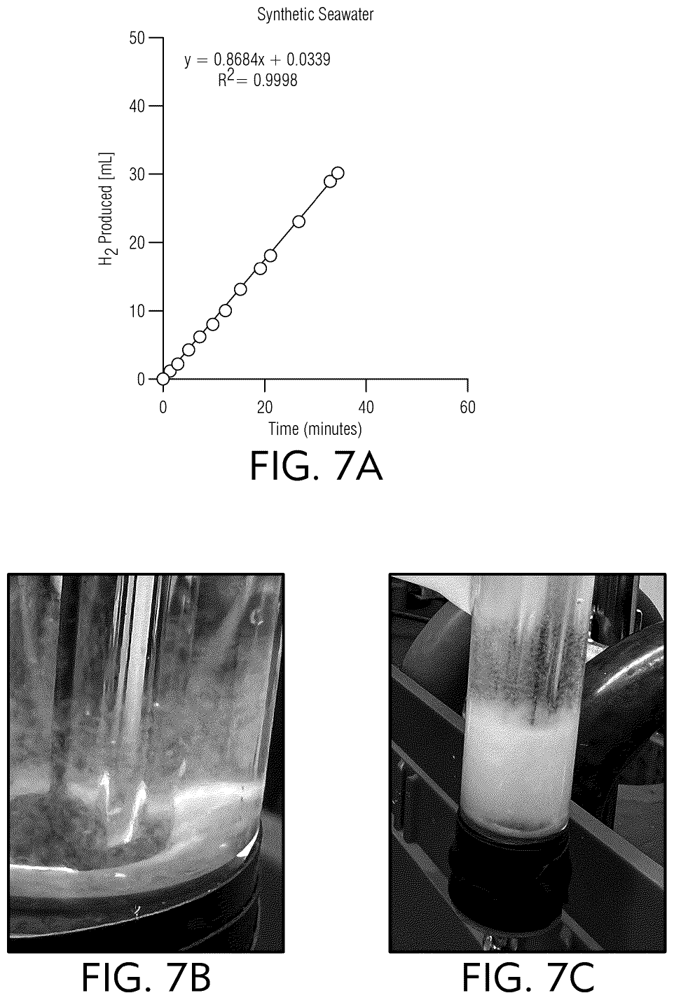

To provide comparative examples, saline (Sample 4) and synthetic Arabian seawater (Sample 5) were subjected to the same electrolysis process as Samples 1-3. FIG. 6 is a plot showing hydrogen production during electrolysis of saline, which reveals a significantly reduced hydrogen production rate relative to Samples 1-3 containing sodium metatungstate. FIG. 7A is a plot showing hydrogen production during electrolysis of synthetic Arabian seawater. Initially, it can be observed from Table 1 that electrolysis of Samples 1-3 comprising an isopolymetalate requires less water (between 20 wt % and 50 wt % water) for comparable rates of hydrogen production relative to electrolysis of seawater (95.2 wt % water).

Moreover, while the hydrogen production rate during electrolysis of synthetic Arabian seawater was comparable to that of Samples 1-3, it can be seen from the photographs in FIGS. 7B (after 10 minutes of seawater electrolysis) and 7C (after 30 minutes of seawater electrolysis) that significant precipitation and scaling occur at the electrodes (cathode shown in FIGS. 7B and 7C). In contrast, electrolysis of Samples 1-3 produced no precipitation at the electrodes, but instead resulted in an opaque blue fluid around the anode and a transparent fluid around the cathode (both solids free). Therefore, the inventive methods described herein are further advantageous in that grime and potential damage to the electrodes is substantially reduced, thereby requiring less cleaning and/or replacement of electrodes. Further, as discussed above, electrolysis of both saline and seawater is associated with the undesirable production of chlorine gas.

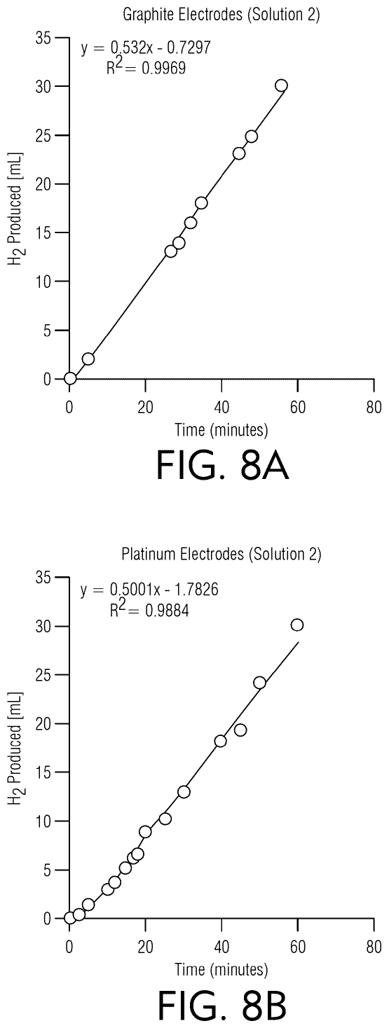

FIGS. 8A and 8B are plots showing hydrogen production during electrolysis of Sample 1 where the material for the anode and the cathode were either both platinum (FIG. 8A) or both graphite (FIG. 8B). The comparable hydrogen production rates for the electrolysis of Sample 1 using either graphite or platinum for the electrodes indicates that the aqueous isopolymetalate solutions described herein are versatile and clean (no precipitation observed) regardless of the electrode material.

As discussed above, surface functionalization of alkalized isopolymetalates may be carried out by contacting the alkalized aqueous electrolyte solution with a modifying agent (e.g., in an admixture) selected from the group consisting of bis(2-ethylhexyl) phthalate, (3-glycidoxypropyl)trimethoxysilane, sodium glucoheptonate, benzaldehyde, benzophenone, silicates, adamantylamine, and combinations thereof, thereby forming a modified alkalized isopolymetalate solution. After reacting alkalized isopolymetalate solutions with (3-glycidyloxypropyl)trimethoxysilane, macroscale correlations between interfacial modifications and thermal and mechanical stability were observed, indicating great adhesion of moieties of the (3-glycidyloxypropyl)trimethoxysilane modifying agent to isopolymetalates, most likely due to covalent bonding.

To investigate the potential for alkalization by reducing agent and isopolymetalate surface modification, an additional experiment was performed wherein 30 uL of a 0.1 M NaBH₄ reducing agent solution, containing 0.35 mmol of bis(2-ethylhexyl) phthalate as a modifying agent, was added to 3 mL of an aqueous electrolyte solution comprising sodium metatungstate at 80 wt % based on the total weight of the aqueous electrolyte solution. The solution was mixed by vortex which caused it to turn dark blue and then colorless due to degassing. As with alkalization by electrolysis, where the solution as the anode turned opaque blue, alkalization by reducing agent also caused the solution to turn blue. Additional experiments demonstrated that the alkalized aqueous electrolyte solutions described herein, when reacted with an admixture, can produce modified isopolymetalate-based fluids with favorable bulk thermal properties for use in high temperature applications (at least 300° F., from 80° F.).

Unless otherwise specified, a range of values, when recited, includes both the upper and lower limits of the range as well as any sub-ranges therebetween. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the indefinite articles “a,” “an,” and the corresponding definite article “the” mean “at least one” or “one or more,” unless otherwise specified. It will also be understood that the various features disclosed in the specification and the drawings can be used in any and all combinations.

As used herein and in the appended claims, the words “comprise,” “has,” and “include” and all grammatical variations thereof are each intended to have an open, non-limiting meaning that does not exclude additional elements or steps.

Reference throughout this specification to “one embodiment,” “embodiments,” “certain embodiments,” “some embodiments,” “various embodiments,” “one or more embodiments,” or “an embodiment” means that a particular feature, structure, material, or characteristic described in connection with the embodiment is included in at least one embodiment of the disclosure. Thus, the appearances of the phrases such as “in embodiments,” “in one or more embodiments,” “in certain embodiments,” “in various embodiments,” “in one embodiment,” “in some embodiments,” or “in an embodiment” in various places throughout this specification are not necessarily referring to the same embodiment. Furthermore, the particular features, structures, materials, or characteristics described in connection with one embodiment may be combined in any suitable manner in one or more other embodiments.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

Having described the subject matter herein in detail and by reference to specific embodiments, it is noted that the various details disclosed herein should not be taken to imply that these details relate to elements that are essential components of the various embodiments described herein. Further, it will be apparent that modifications and variations are possible without departing from the scope herein, including, but not limited to, embodiments defined in the appended claims.

What is claimed is:

1. A wellbore fluid produced through alkalization of an aqueous electrolyte solution comprising an isopolymetalate, wherein the wellbore fluid has a pH greater than or equal to 5.

2. The wellbore fluid of claim 1, wherein the isopolymetalate comprises an isopolytungstate.

3. The wellbore fluid of claim 1, wherein the aqueous electrolyte solution comprises sodium metatungstate, ammonium metatungstate, or both, and wherein the isopolymetalate comprises metatungstate from the sodium metatungstate, ammonium metatungstate, or both.

4. The wellbore fluid of claim 1, wherein the aqueous electrolyte solution comprises an isopolymetalate salt comprising an anion and a cation, wherein the isopolymetalate is the anion of the isopolymetalate salt.

5. The wellbore fluid of claim 4, wherein the isopolymetalate salt is present in the aqueous electrolyte solution in an amount between 10 wt % and 90 wt %, based on the total weight of the aqueous electrolyte solution.

6. The wellbore fluid of claim 4, wherein the isopolymetalate salt is present in the aqueous electrolyte solution in an amount between 25 wt % and 80 wt %, based on the total weight of the aqueous electrolyte solution.

7. The wellbore fluid of claim 4, wherein the isopolymetalate salt is present in the aqueous electrolyte solution in an amount between 50 wt % and 75 wt %, based on the total weight of the aqueous electrolyte solution.

8. The wellbore fluid of claim 1, wherein before being alkalized, the aqueous electrolyte solution has a pH less than or equal to 4.0.

9. The wellbore fluid of claim 1, wherein the wellbore fluid is substantially free of chlorine, zinc, and cesium.

10. The wellbore fluid of claim 1, wherein the alkalization is performed using an electrolytic cell comprising:
a chamber configured to hold the aqueous electrolyte solution;
a cathode immersed in the aqueous electrolyte solution;
an anode immersed in the aqueous electrolyte solution and fluidly connected to the cathode; and
an electrical power source configured to generate a potential difference between the cathode and the anode.

11. A method for producing a wellbore fluid comprising alkalizing an aqueous electrolyte solution comprising an isopolymetalate.

12. The method of claim 11, wherein the alkalizing comprises:
providing an aqueous electrolyte solution in a chamber, the aqueous electrolyte solution comprising an isopolymetalate;
immersing a cathode in the aqueous electrolyte solution;
immersing an anode in the aqueous electrolyte solution such that the anode is fluidly connected to the cathode; and
generating a potential difference between the cathode and the anode to alkalize the aqueous electrolyte solution and produce the wellbore fluid, wherein the wellbore fluid has a pH greater than or equal to 5.

13. The method of claim 12, wherein the isopolymetalate comprises an isopolytungstate.

14. The method of claim 13, wherein the aqueous electrolyte solution comprises sodium metatungstate, ammonium metatungstate, or both, and wherein the isopolymetalate comprises metatungstate from the sodium metatungstate, ammonium metatungstate, or both.

15. The method of claim 11, wherein the alkalizing comprises contacting the aqueous electrolyte solution comprising an isopolymetalate with a reducing agent.

16. The method of claim 15, wherein the reducing agent comprises sodium borohydride.

17. The method of claim 11, further comprising contacting the alkalized aqueous electrolyte solution with a modifying agent thereby forming a modified alkalized isopolymetalate solution.

18. The method of claim 17, wherein the modifying agent is selected from the group consisting of (3-glycidoxypropyl)trimethoxysilane, sodium glucoheptonate, benzaldehyde, benzophenone, silicates, adamantylamine, and combinations thereof.

19. A method for generating hydrogen gas, the method comprising:
providing an aqueous electrolyte solution in a chamber, the aqueous electrolyte solution comprising an isopolymetalate;
immersing a cathode in the aqueous electrolyte solution;
immersing an anode in the aqueous electrolyte solution such that the anode is fluidly connected to the cathode; and
generating a potential difference between the cathode and the anode to alkalize the aqueous electrolyte solution and produce hydrogen gas.

20. The method of claim 19, wherein the aqueous electrolyte solution comprises an isopolymetalate salt comprising an anion and a cation, wherein the isopolymetalate is the anion of the isopolymetalate salt.

21. The method of claim 20, wherein the isopolymetalate salt is present in the aqueous electrolyte solution in an amount between 10 wt % and 90 wt %, based on the total weight of the aqueous electrolyte solution.

22. The method of claim 19, wherein the aqueous electrolyte solution comprises sodium metatungstate, ammonium metatungstate, or both, and wherein the isopolymetalate comprises metatungstate from the sodium metatungstate, ammonium metatungstate, or both.
